(19) United States
(12) Patent Application Publication
(10) Pub. No.: US 2011/0207875 A1
(43) Pub. Date: Aug. 25, 2011

(54) COMPOSITION FOR PRODUCING AN ADJUSTING DEVICE OF A MOTOR VEHICLE

(76) Inventors: Wolfgang Wachter, Kueps (DE); Udo Taubmann, Rodach-Suelzfeld (DE)

(21) Appl. No.: 13/126,156

(22) PCT Filed: Oct. 28, 2009
(86) PCT No.: PCT/EP09/64210

§ 371 Date: Apr. 26, 2011

(30) Foreign Application Priority Data
Nov. 10, 2008 (DE) 10 2008 057 240.3

(51) Int. Cl. C08L 77/06; C08G 69/26; C08L 27/18

(52) U.S. Cl. 524/514; 525/420; 525/178; 524/606

(57) ABSTRACT

The invention relates to a use of a composition containing a partly crystalline, partly aromatic polyamide for producing at least a part of an adjusting device of a motor vehicle. The composition is impact-modified by addition of at least one elastomer with a proportion of 1% to 10% in the composition.

### CROSS-REFERENCE TO A RELATED APPLICATION

This application is a National Phase Patent Application of International Patent Application Number PCT/EP2009/064210, filed on Oct. 28, 2009, which claims priority of German Patent Application Number 10 2008 057 240.3, filed on Nov. 10, 2008.

### BACKGROUND

This invention relates to the use of a composition for producing at least a part of an adjusting device of a motor vehicle and to an adjusting device for adjusting an adjustable part of a motor vehicle.

Parts of an adjusting device of a motor vehicle, in particular those parts which in operation of the adjusting device are subject to friction, must satisfy high requirements as regards their mechanical, in particular tribological properties. This applies for example to
gearwheels of the adjusting device which engage in other transmission parts for power transmission and in operation of the adjusting device move relative to other parts,
guide elements, for example guide rails of a window lifter or a seat adjuster, for guiding parts of the adjusting device, and
sliding elements, for example guided carriers of a window lifter, guide webs of a seat adjuster or the like.

Nowadays, such parts of an adjusting device above all are preferably made of plastics for cost reasons. It should be noted, however, that the parts must have sufficiently good mechanical properties over a comparatively large temperature range—corresponding to the operating temperature range of the adjusting device of e.g. −40° C. to 120° C.—and must ensure a low-friction and low-wear operation of the adjusting device even at high operating temperatures.

Conventionally, for example polyacetals, also referred to as polyoxymethylene (POM), or polyether ether ketones (PEEK) are used for producing parts of an adjusting device. Polyacetals are inexpensive, but have the disadvantage of a pronouncedly temperature-dependent viscoelastic behavior which at elevated temperatures leads to a deterioration of the mechanical properties of the parts produced. Polyether ether ketones, which represent high-temperature resistant thermoplastic materials, have almost consistently good mechanical properties over a large temperature range, but are very expensive.

### SUMMARY

It is the object of the present invention to provide a use of a composition for producing at least a part of an adjusting device and an adjusting device, which provide for an inexpensive production of the parts of the adjusting device with mechanical properties sufficient for the operation of the adjusting device.

According to an exemplary embodiment of the invention a composition containing a partly crystalline, partly aromatic polyamide for producing at least a part of an adjusting device of a motor vehicle is used, wherein the composition is impact-modified by addition of at least one elastomer with a proportion of 1% to 10% in the composition.

The invention is based on the idea to use a composition for manufacturing parts of an adjusting device, which on the one hand is inexpensive and on the other hand has sufficiently good mechanical properties over a large temperature range (for example −40° C. to 120° C.), so that in particular at high operating temperatures around and beyond for example 90° C. the proper function of the adjusting device is ensured. For this purpose, a partly crystalline, partly aromatic polyamide is used for producing in particular parts loaded in operation of the adjusting device, which has a high strength even at the occurring high operating temperatures.

Partly crystalline polyamide is understood to be a polyamide which on cooling from the melt forms crystalline domains (first order phase transition). In the process, not the entire melt solidifies in a crystalline manner, but there are also formed amorphous domains. The ratio between crystalline and amorphous domains is determined by the chemical nature of the polyamide and the cooling conditions, wherein the crystallization can be promoted or impeded in addition by nucleating or anti-nucleating additives. Easily crystallizing polyamides include for example the so-called PA 46 or the PA 66, the hardly crystallizing polyamides include the so-called PA mXD6 from m-xylylene diamine and adipic acid or certain copolyamides.

A partly aromatic polyamide is understood to be a polyamide whose monomers are partly derived from aromatic mother substances, e.g. a polyamide from hexamethylene diamine and terephthalic acid (PA 6T).

Exemplary, the partly crystalline, partly aromatic polyamide is prepared on the basis of hexamethylene diamine and in addition terephthalic acid. In addition, various further comonomers can be contained in the polyamide.

An example for such composition is the polyamide PA6T/XT. The use of the polyamide PA6T/XT provides for a composition which has a high strength even at high temperatures, a high heat deflection temperature, a low water absorption rate, a low wear, a low friction and a good chemical resistance. The use of this polyamide has the further advantage that due to a comparatively high crystallization and curing rate short processing cycles become possible during the production of the parts of the adjusting device.

The partly crystalline, partly aromatic polyamide for example can have a proportion (in percent by weight) of 80% to 100%, in particular 80% to 90% or 90% to 100% in the composition.

In addition, to obtain an impact-modified material, elastomers are added to the composition with a proportion of 1% to 10%. Useful impact modifiers generally include compounds from the group including sulfonamides, acrylamides, urea derivatives such as hydroxyethylethylene urea, monoethers of polyvalent C₁-C₂₀ alcohols, polytrimethylol propane adipinate, lactates, lactams as well as polyamides, lactones and their polymers, carbohydrates such as starch, aminosorbitol, hydroxyethyl glycosides, inorganic and organic sulfites and hydroxymethyl sulfonates, polyester polyols, ethylene/vinyl acetate/carbon monoxide copolymers, polyacrylates, polyvinyl alcohol, polyvinyl acetates, amino- or hydroxyl-terminated polysiloxane block copolymers, barium sulfates and/or precipitated calcium carbonates, preferably polyvinyl butyrals, functional-group-terminated butadiene homopolymers and/or acrylonitrile-butadiene copolymers. The action principle of the impact modifiers consists in their ability to stop microcracks running through the material. One prerequisite for this is a homogeneous distribution in the molding compound, which provides for an absorption of the impact energy introduced. Chiefly used impact modifiers include elastomers, for example EPR, EPDM, NR, SEBS, PIB, PE-VLD or metallocene-based thermoplastic elastomers. It is important that the impact modifiers either have a compatibility partly up to the chemical coupling with the composition by coordinative bonds or a separate phase similar to an interpenetrating network.

In an advantageous variant, the composition in addition is tribologically modified by adding polytetrafluoroethylene (PTFE) with a proportion of 1% to 10% in the composition. Due to the tribological modification, the parts produced with the composition have advantageous sliding properties and provide for a particularly low-friction and low-wear operation of the adjusting device.

The use of a partly crystalline, partly aromatic polyamide provides for the production of parts of an adjusting device which over a large temperature range, for example −40° C. to 120° C., have sufficiently good mechanical properties and which in particular also at high operating temperatures satisfy the strength requirements placed on the adjusting device. An additional reinforcement, for example a fiber reinforcement by glass or carbon fibers, is not required. The use of a non-fiber-reinforced composition has the further advantage that on cooling after forming the composition has a substantially isotropic shrinkage and the distortion in the parts produced therefore is minimized. In addition, the parts produced have an increased weld line strength as compared to fiber-reinforced workpieces.

The composition containing the partly crystalline, partly aromatic polyamide advantageously has a glass point above 115° C. and in a temperature range from −40° C. to 120° C. a shear modulus of at least 650 MPa. Glass point designates the temperature point at which solid—solidified—amorphous fiber regions start to transform into a viscoelastic—easily deformably condition. Above the glass point, the shear modulus drastically decreases, so that workpieces produced from the composition should not be used at temperatures above the glass point.

The above-described composition can be used in particular for producing gearwheels of a transmission of the adjusting device, of guide elements of the adjusting device and/or of sliding elements of the adjusting device. Other parts, in particular housing parts, can also be fabricated from the described composition and have advantageous mechanical properties in operation of the adjusting device, in particular at high operating temperatures.

The object is also solved by an adjusting device for adjusting an adjustable part of a motor vehicle, in which at least one gearwheel of a transmission, a guide element and/or a sliding element are produced from a composition containing a partly crystalline, partly aromatic polyamide, wherein the composition is impact-modified by addition of at least one elastomer with a proportion of 1% to 10% in the composition.

### BRIEF DESCRIPTION OF THE DRAWINGS

The idea underlying the invention will be explained in detail below with reference to the embodiments illustrated in the Figures and the Tables.

FIG. 1 shows a view of an adjusting device formed as roll-up sunshield drive.

FIG. 2 shows a cutout view of the adjusting device of FIG. 1.

FIG. 3 shows an enlarged view of a transmission of the adjusting device.

FIG. 4 shows an exploded representation of the transmission of the adjusting device.

FIG. 5 shows another exploded representation of the adjusting device.

FIG. 6 shows a view of a carrier of the adjusting device in a guide rail.

FIG. 7 shows a graphical representation of the courses of the shear modulus of different compositions for producing at least one part of an adjusting device, in dependence on the temperature.

### DETAILED DESCRIPTION

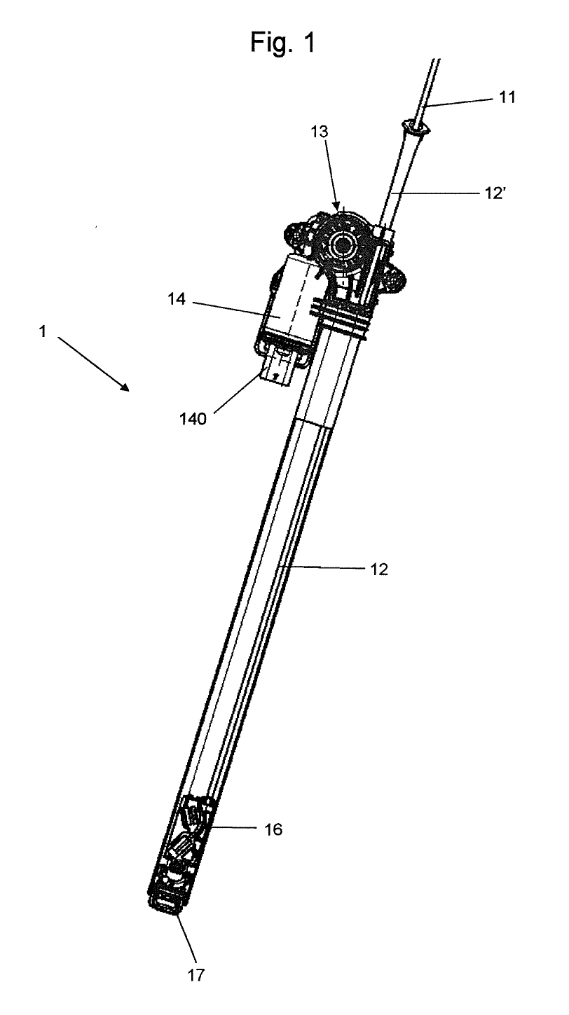

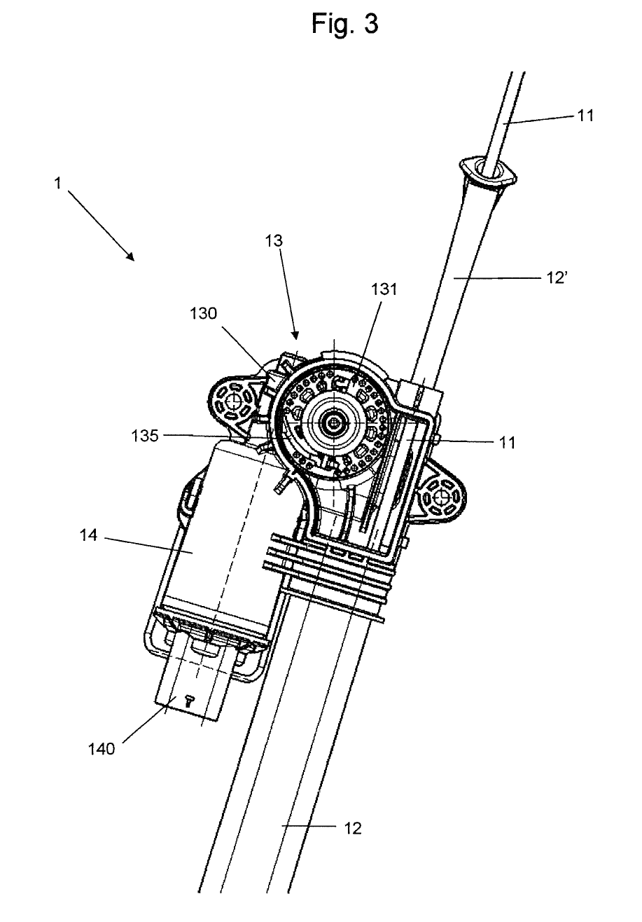

FIGS. 1 to 6 show an embodiment of an adjusting device 1 formed as roll-up sunshield drive for mounting at a vehicle door. The adjusting device 1 can be connected with a roll-up sunshield to be moved along a window pane of the vehicle door and in the condition mounted at the vehicle door serves for the power-driven adjustment of the roll-up sunshield.

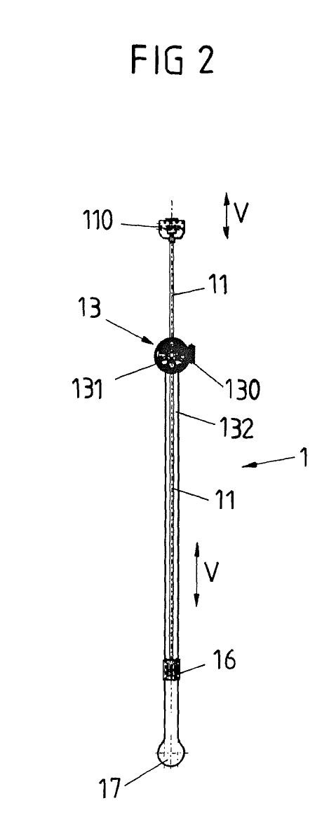

The adjusting device 1 is formed in the manner of a single-strand cable window lifter and is shown in FIG. 2 in a functional representation. The adjusting device 1 includes a push rod 11 which is guided via a carrier 16 in a longitudinal guide 12 extending along the adjustment direction V (see FIG. 1). The carrier 16 is connected with a pulling means 132 and via the pulling means 132 coupled to a transmission 13 which is driven via a driving device 14.

The pulling means 132 which for example constitutes a steel cable forms a closed cable loop and extends towards the carrier 16 proceeding from a cable drum 131, is connected with the carrier 16, extends further to a deflection 17 and from there back to the cable drum 131. On the way back, the pulling means 132 is slidingly guided along the carrier 16, so that the carrier 16 is connected with the pulling means 132 only on one side and the pulling means 132 slides along the other side of the carrier 16.

Via a drive worm 130 coupled with the drive motor 14, the cable drum 131 is driven in a stepped-down manner. In operation, the drive worm 130 puts the cable drum 131 into a rotary movement. The pulling means 132 thereby is wound onto the cable drum 131 via its one end, while at the same time it is unwound from the cable drum 131 via its other end, so that the length of the cable loop on the whole is not changed, but the pulling means 132 together with the carrier 16 connected with the pulling means 132 is shifted in the longitudinal guide 12. Via the carrier 16, the pulling means 132 is connected with the push rod 11, which thus likewise is shifted together with the carrier 16 and is extended from the longitudinal guide 12 or retracted into the longitudinal guide 12 along the adjustment direction V.

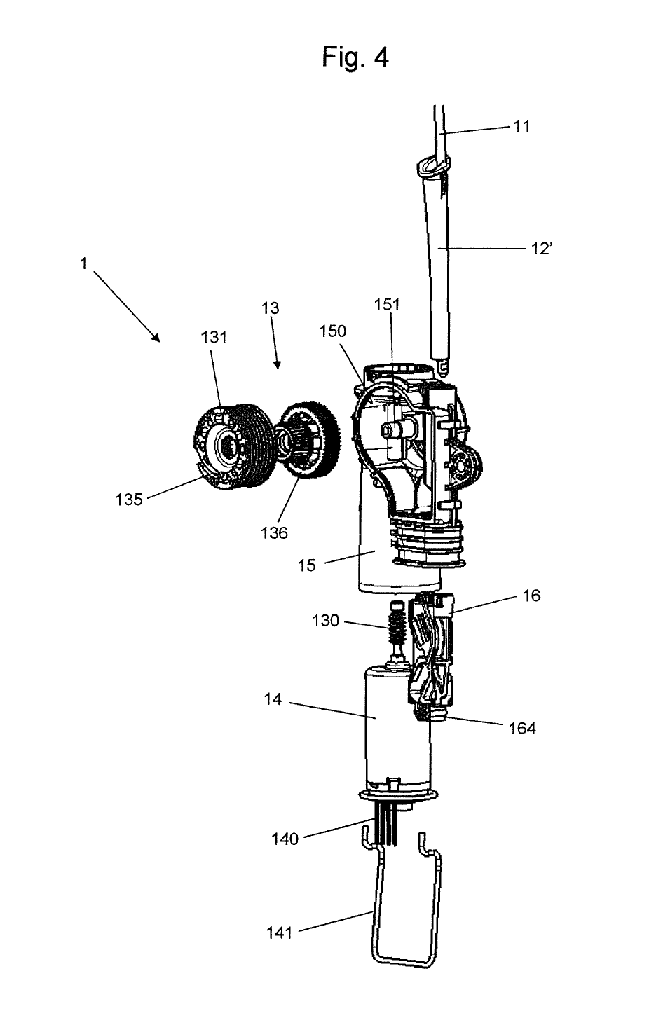

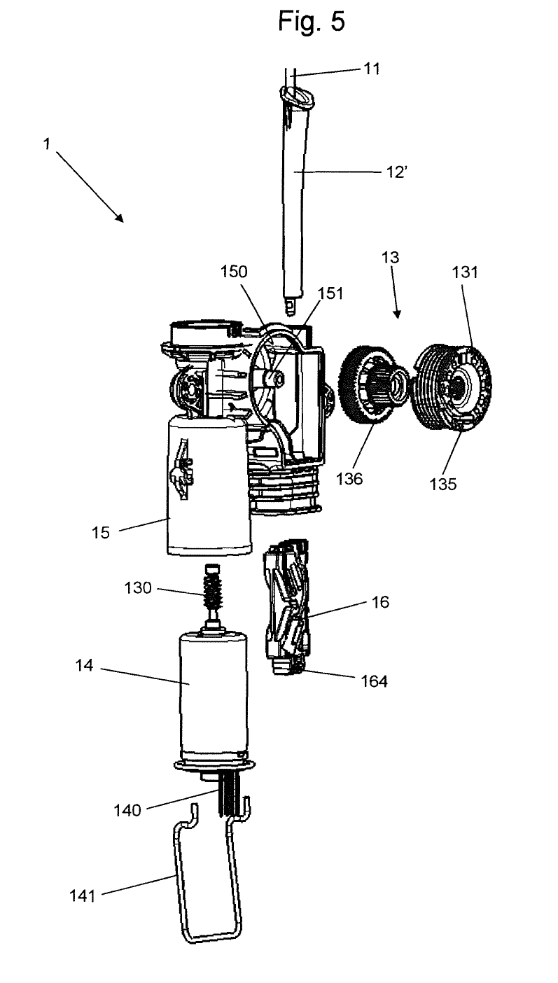

Via a drive worm 130 (see FIGS. 4 and 5) the drive motor 14 is in engagement with a gearwheel 136. For this purpose, the drive worm 130 has a worm toothing on its outer circumference, which engages in a toothing on the outer circumference of the gearwheel 136. The gearwheel 136 is firmly engaged in a cable drum 131, so that on driving the gearwheel 136 the cable drum 131 is put into a rotary movement.

The drive motor 14 configured as electric motor includes an electrical connection 140 via which an electrical supply line can be connected with the drive motor 14.

On its outer circumference, the cable drum 131 includes grooves for accommodating the pulling means 132.

The drive motor 14, the gearwheel 136 and the cable drum 131 are arranged in a housing 15 which includes a cylindrical receptacle 150 for enclosing the gearwheel 136 and the cable drum 131. The drive motor 14 is retained in the housing 15 via a clamp 141.

The cylindrical receptacle 150 can be formed to cooperate with the cable drum 131 with its inner cylindrical surface such that in operation of the adjusting device 1 the pulling means 132 is retained at the cable drum 131 in the grooves for accommodating the pulling means 132 and cannot get out of the grooves of the cable drum 131.

In the cylindrical receptacle 150 an axle 151 is formed in the form of a trunnion onto which the gearwheel 136 and the cable drum 131 are put for rotatable support.

The cable drum 131 includes two receptacles 135 in the form of nipple chambers via which the ends of the pulling means 132 can be connected with the cable drum 131. The pulling means 132 is connected with the cable drum 131 such that when the cable drum 131 rotates in operation of the adjusting device 1, one end of the pulling means 132 is wound onto the cable drum 131 and at the same time the other end of the pulling means 132 is unwound from the cable drum 131, so that the cable loop formed by the pulling means 132 maintains a constant length.

The pulling means 132 (see FIG. 2) extends from the cable drum 131 in the longitudinal guide 12 towards the deflection 17 and from the deflection 17 back to the cable drum 131 and is coupled with the carrier 16 such that a displacement of the pulling means 132 as a result of a rotary movement of the cable drum 131 is converted into a longitudinal movement of the carrier 16 along the longitudinal guide 12. The carrier 16 is coupled with the push rod 11, so that by moving the carrier 16 the push rod 11 is adjustable along the longitudinal guide 12.

At its upper, transmission-side end the longitudinal guide 12 is connected with an additional longitudinal guide 12′ in the form of a cylindrical tube in which the push rod 11 is guided in sections. The additional longitudinal guide 12′ in particular serves to guide the push rod 11 through a body part of a vehicle and support the same therein, wherein due to the separate configuration the longitudinal guide 12′ can be mounted separate from the longitudinal guide 12 and can be inserted from outside for example into an opening of the body part and be latchingly connected with the longitudinal guide 12.

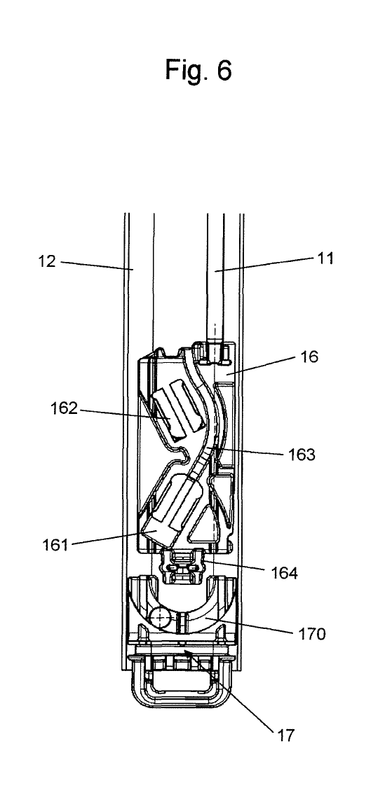

A detailed view of the carrier 16 is shown in FIG. 6. The carrier 16 is slidingly guided in the longitudinal guide 12 between the deflection 17 and the transmission 13 and includes nipple chambers 161, 162 for connecting the pulling means 132 with the carrier 16. The pulling means 132 is inserted in longitudinal guides 163 leading towards the nipple chambers 161, 162 and via nipples arranged at the cable ends of the pulling means 132 accommodated in the nipple chambers 161, 162 such that pulling forces can be transmitted to the carrier 16.

At its lower end facing the deflection 17, the carrier 16 has a trunnion 164 which can be introduced into a corresponding receptacle at the deflection 17. Together with the deflection 17 the trunnion 164 defines a stop position with retracted push rod 11, in which the carrier 16 has been moved to the lower end of the longitudinal guide 12. Via the trunnion 164, the carrier 16 is latchingly retained at the deflection 17, so that the push rod 11 is fixed in this retracted position.

The deflection 17 formed as one-part deflection piece includes a cable guide 170 in the form of a semicircularly bent tube section for the deflecting guidance of the pulling means 132. In operation, the pulling means 132 slides through the cable guide 170 and thus is deflected by 180°. The deflection 17 constitutes a plastic part and is inserted into the longitudinal guide 12 from below.

The adjusting device 1 described above with reference to FIGS. 1 to 6 includes parts which advantageously are produced by using a composition containing a partly crystalline, partly aromatic polyamide, in particular PA6T/XT. The use of such a composition has the advantage that parts produced therefrom have sufficiently good mechanical properties with a high strength over a large temperature range, for example an operating temperature range from −40° C. to 120° C. The parts which advantageously are produced from such a composition include the push rod 11, the longitudinal guide 12, 12′, the drive worm 130, the cable drum 131, the receptacle 135, the gearwheel 136, the housing 15, the carrier 16 and the deflection 17. In particular, those parts of the adjusting device 1 are produced from the composition containing the partly crystalline, partly aromatic polyamide, which—like the drive worm 130 and the gearwheel 136—serve the power transmission in operation of the adjusting device 1 or—like the longitudinal guide 12, 12′ and the carrier 16—represent parts sliding along each other.

The composition can contain elastomers as impact modifiers and/or polytetrafluoroethylene (PTFE) as tribological modifier for improving the sliding properties.

The composition containing the partly crystalline, partly aromatic polyamide advantageously is not additionally reinforced and thus contains no additional glass or carbon fibers.

A first example of a composition contains
a proportion (in percent by weight) of 96% to 97% of PA6T/XT, and
a proportion of 3% to 4% of an impact modifier.

Further additives with a proportion of 0.1% to 1% can be added.

A second example of a composition contains
a proportion of 87% to 88% of PA6T/XT,
a proportion of 3% to 4% of an impact modifier, and
a proportion of 8% to 9% of polytetrafluoroethylene (PTFE).

In addition, further additives can be added with a proportion of 0.1% to 1%.

The mechanical and thermal properties of the first example of the composition are listed in the following Table 1.

TABLE 1

| | | | |
|---|---|---|---|
| Standard | Unit | Condition | Value |

Mechanical properties

| | | | | | |
|---|---|---|---|---|---|
| Modulus of | 1 mm/min | ISO527 | MPa | dry | 2500 |
| elasticity | | | | conditioned | 2800 |
| Tensile force at | 5 mm/min | ISO527 | MPa | dry | 75 |
| break | | | | conditioned | 75 |
| Elongation at | 5 mm/min | ISO527 | % | dry | 3.5 |
| break | | | | conditioned | 5.0 |
| Impact resistance | Charpy, | ISO179/1eU | kJ/m² | dry | 80 |
| | 23° C. | | | conditioned | 80 |
| Notch impact | Charpy, | ISO179/1eA | kJ/m² | dry | 5.5 |
| resistance | 23° C. | | | conditioned | 7.0 |

Thermal properties

| | | | | | |
|---|---|---|---|---|---|
| Melting point | DSC | ISO11357 | ° C. | dry | 295 |
| Heat deflection | 1.80 MPa | ISO75 | ° C. | dry | 110 |
| temperature | | | | | |
| HDT/A | | | | | |
| Heat deflection | 0.45 MPa | ISO75 | ° C. | dry | 140 |
| temperature | | | | | |
| HDT/B | | | | | |

General properties

| | | | | | |
|---|---|---|---|---|---|
| Density | | ISO1183 | g/cm³ | dry | 1.13 |
| Water absorption | 240 h at | ISO62 | % | | 2.7 |
| | 95° C. | | | | |

The mechanical and thermal properties of the second example of the composition are indicated in the following Table 2.

TABLE 2

| | | | |
|---|---|---|---|
| Standard | Unit | Condition | Value |

Mechanical properties

| | | | | | |
|---|---|---|---|---|---|
| Modulus of | 1 mm/min | ISO527 | MPa | dry | 2500 |
| elasticity | | | | conditioned | 2800 |
| Tensile force at | 5 mm/min | ISO527 | MPa | dry | 70 |
| break | | | | conditioned | 60 |
| Elongation at | 5 mm/min | ISO527 | % | dry | 3.0 |
| break | | | | conditioned | 4.5 |
| Impact resistance | Charpy, | ISO179/1eU | kJ/m² | dry | 50 |
| | 23° C. | | | conditioned | 50 |
| Notch impact | Charpy, | ISO179/1eA | kJ/m² | dry | 3 |
| resistance | 23° C. | | | conditioned | 4 |

Thermal properties

| | | | | | |
|---|---|---|---|---|---|
| Melting point | DSC | ISO11357 | ° C. | dry | 295 |
| Heat deflection | 1.80 MPa | ISO75 | ° C. | dry | 110 |
| temperature | | | | | |
| HDT/A | | | | | |
| Heat deflection | 0.45 MPa | ISO75 | ° C. | dry | 160 |
| temperature | | | | | |
| HDT/B | | | | | |

General properties

| | | | | | |
|---|---|---|---|---|---|
| Density | | ISO1183 | g/cm³ | dry | 1.19 |
| Water absorption | 240 h at | ISO62 | % | | 2.4 |
| | 95° C. | | | | |

The first example (Table 1) relates to an impact-modified composition. The second example (Table 2) relates to an impact-modified and tribologically modified composition.

Both compositions advantageously are processed in a dry condition. The processing temperature of the melt should lie between 305° C. and 330° C. (the melting point of the first and second example of the composition each is about 295° C.). The forming temperature should lie between 115° C. and 140° C. Both the first example and the second example of the composition have a high crystallization rate and thus provide for short processing times at a high injection speed during injection molding.

The use of the described examples of the composition provides for producing the parts of the adjusting device 1 in an inexpensive way with advantageous mechanical properties of the parts over the required temperature range of for example −40° C. to 120° C. Due to the fact that the composition is not fiber-reinforced, shrinkage is approximately isotropic, so that the distortion in the parts produced is minimal and the parts in addition have a high weld line strength as compared to fiber-reinforced workpieces.

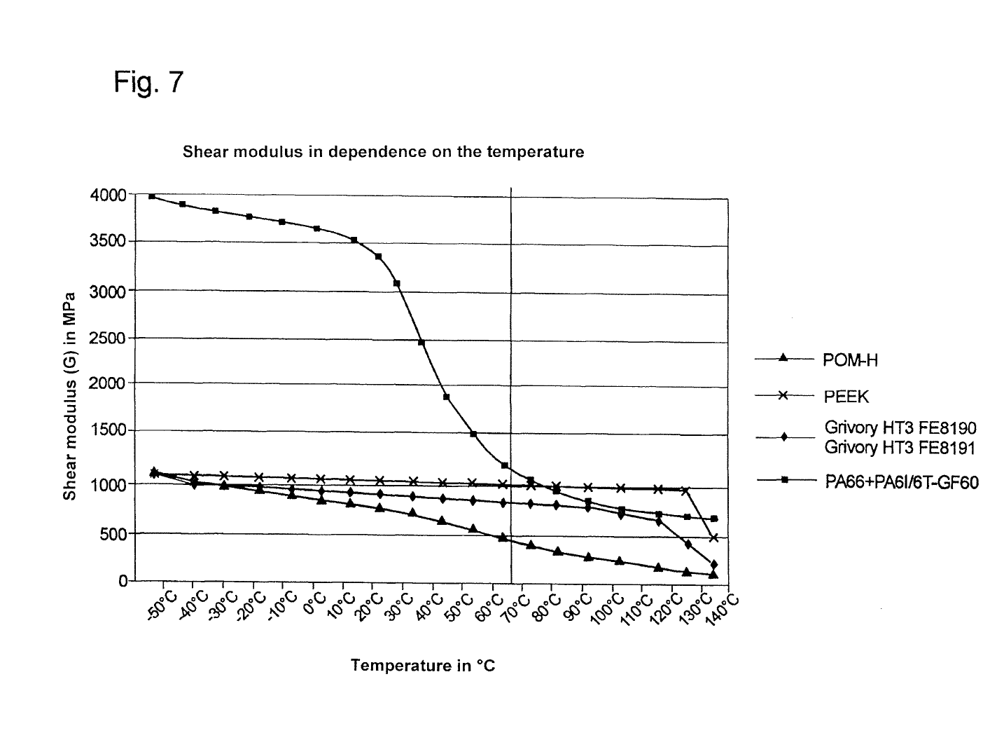

FIG. 7 shows the temperature dependence of the shear modulus G (in MPa) for different materials. The material referred to as POM-H is a composition on the basis of a polyacetal. The material referred to as PEEK is a material on the basis of a polyether ether ketone. The materials Grivory HT3 FE8190 and Grivory HT3 FE8191 are compositions realizing the invention in accordance with the above-mentioned first and second examples of the composition. The material PA66+PA61/6T-GF60 represents a fiber-reinforced material.

As shown in FIG. 7, the polyacetal-based material POM-H exhibits a viscoelastic behavior with decreasing shear modulus at rising temperature. The shear modulus of the material POM-H at low temperatures lies in the range of the shear modulus of the other materials, but at high temperatures distinctly below the shear modulus of the other materials.

Over a range from −40° C. to 135° C. the material PEEK has an almost constant shear modulus between 1000 MPa and 1100 MPa. A disadvantage of the material PEEK, however, is the high price as compared to the other materials.

Over a temperature range from −40° C. to about 120° C. the materials Grivory HT3 FE8190 and Grivory HT3 FE8191 realizing the invention have an only slightly changing shear modulus between 1000 MPa and 750 MPa. The shear modulus lies slightly below the shear modulus of the material PEEK. The strength of the materials Grivory HT3 FE8190 and Grivory HT3 FE8191, however, is sufficient at a price which distinctly lies below that of PEEK.

Both the material PEEK and the materials Grivory HT3 FE8190 and Grivory HT3 FE8191 have a so-called glass point which lies at about 135° C. and 125° C., respectively. At temperatures above the glass point, the shear modulus drastically decreases, so that parts fabricated from these materials should not be used at temperatures higher than the temperature of the glass point. However, the glass point of PEEK and of Grivory HT3 FE8190 and Grivory HT3 FE8191, respectively, each lies above the operating temperature range normally occurring in an adjusting device 1.

In FIG. 7, the shear modulus of the fiber-reinforced material PA66+PA61/6T-GF60 also is indicated, which at low temperatures lies far above the shear modulus of PEEK and of Grivory HT3 FE8190 and Grivory HT3 FE8191, respectively.

The adjusting device 1 described with reference to FIGS. 1 to 6 here should merely be understood as an example for the use of parts fabricated from a composition containing a partly crystalline, partly aromatic polyamide. Parts fabricated from such a composition, in particular gearwheels, guide elements, guide rails and sliding elements, basically can be used in different adjusting devices of a vehicle, in particular in a window lifter, a seat length adjuster, a seat height adjuster, a seat inclination adjuster, a trunk cover, a sliding roof cover, a belt adjuster and the like. In principle, the described composition can be used in all adjusting devices whose parts must satisfy certain strength requirements over a comparatively large temperature range.

1-14. (canceled)

15. A use of a composition containing a partly crystalline, partly aromatic polyamide for producing at least a part of an adjusting device of a motor vehicle, wherein the composition is impact-modified by addition of at least one elastomer with a proportion of 1% to 10% in the composition.

16. The use according to claim 15, wherein the partly crystalline, partly aromatic polyamide contains hexamethylene diamine.

17. The use according to claim 15, wherein the partly crystalline, partly aromatic polyamide contains terephthalic acid.

18. The use according to claim 15, wherein the partly crystalline, partly aromatic polyamide contains at least one comonomer.

19. The use according to claim 15, wherein the partly crystalline, partly aromatic polyamide constitutes PA6T/XT.

20. The use according to claim 15, wherein the partly crystalline, partly aromatic polyamide has a proportion of 80% to 100% in the composition.

21. The use according to claim 20, wherein the partly crystalline, partly aromatic polyamide has a proportion of 80% to 90% in the composition.

22. The use according to claim 20, wherein the partly crystalline, partly aromatic polyamide has a proportion of 90% to 100% in the composition.

23. The use according to claim 15, wherein the composition is tribologically modified by adding polytetrafluoroethylene with a proportion of 1% to 10% in the composition.

24. The use according to claim 15, wherein the composition is not additionally fiber-reinforced.

25. The use according to claim 15, wherein the composition containing the partly crystalline, partly aromatic polyamide has a glass point above 115° C.

26. The use according to claim 15, wherein in a temperature range from −40° C. to 120° C. the composition containing the partly crystalline, partly aromatic polyamide has a shear modulus of at least 650 MPa.

27. The use according to claim 15 for producing at least one gearwheel of a transmission of the adjusting device, a guide element of the adjusting device and/or a sliding element of the adjusting device.

28. An adjusting device for adjusting an adjustable part of a motor vehicle, in which at least one gearwheel of a transmission, a guide element and/or a sliding element are produced from a composition containing a partly crystalline, partly aromatic polyamide, wherein the composition is impact-modified by addition of at least one elastomer with a proportion of 1% to 10% in the composition.
